(19) United States
(12) Patent Application Publication
(10) Pub. No.: US 2025/0060651 A1
(43) Pub. Date: Feb. 20, 2025

(54) CAMERA AND ELECTRONIC APPARATUS

(71) Applicant: GUANGDONG OPPO MOBILE TELECOMMUNICATIONS CORP., LTD., Dongguan (CN)

(72) Inventors: Jiawei CHEN, Dongguan (CN); Yi WEI, Dongguan (CN); Xiang LI, Dongguan (CN); Pan YU, Dongguan (CN); Wentao WANG, Dongguan (CN)

(73) Assignee: GUANGDONG OPPO MOBILE TELECOMMUNICATIONS CORP., LTD., Dongguan (CN)

(21) Appl. No.: 18/935,134

(22) Filed: Nov. 1, 2024

Related U.S. Application Data
(63) Continuation of application No. PCT/CN2022/139018, filed on Dec. 14, 2022.

(30) Foreign Application Priority Data
Jun. 6, 2022 (CN) 202210630693.7

(51) Int. Cl. G03B 5/00; G03B 30/00; H04N 23/667

(52) U.S. Cl. CPC G03B 5/00; G03B 30/00; H04N 23/667; G03B 2205/0046

(57) ABSTRACT

A camera and an electronic apparatus are provided. The camera includes an image sensor and a lens assembly. The lens assembly is configured to form an image on the image sensor. The lens assembly includes multiple lens groups, and the multiple lens groups are arranged along an optical axis of the lens assembly. At least one of the multiple lens groups is movable relative to the image sensor to switch the lens assembly between a first mode and a second mode. A focusing object distance of the lens assembly in the first mode is less than a focusing object distance of the lens assembly in the second mode. The focusing object distance of the lens assembly in the first mode is less than 10 mm.

### CROSS REFERENCE TO RELATED APPLICATIONS

The present application is a continuation-application of International (PCT) Patent Application No. PCT/CN2022/139018, filed on Dec. 14, 2022, which claims priority to Chinese Patent Application No. 202210630693.7, filed on Jun. 6, 2022, the contents of which are incorporated herein by reference in their entireties.

### TECHNICAL FIELD

The present disclosure relates to the technical field of electronic equipment, and in particular, to a camera and an electronic apparatus.

### BACKGROUND

In the related art, the macro shooting function on a mobile phone is realized through an ultra-wide angle camera, and the microscopic shooting function is realized through an additional dedicated camera. However, it is difficult for a single camera on a mobile phone to realize the macro shooting function and the microscopic shooting function at the same time, which leads to a limited usage scenario.

### SUMMARY OF THE DISCLOSURE

The present disclosure provides a camera and an electronic apparatus.

Some embodiments of the present disclosure include an image sensor and a lens assembly; the lens assembly is configured to form an image on the image sensor; the lens assembly includes multiple lens groups, and the multiple lens groups are arranged along an optical axis of the lens assembly.

At least one of the multiple lens groups is movable relative to the image sensor to switch the lens assembly between a first mode and a second mode; a focusing object distance of the lens assembly in the first mode is less than a focusing object distance of the lens assembly in the second mode; the focusing object distance of the lens assembly in the first mode is less than 10 mm.

The camera in some embodiments of the present disclosure switches the lens assembly between the first mode and the second mode through the movement of the lens group relative to the image sensor. The first mode may correspond to the shooting of the camera in the microscopic mode. The second mode may correspond to the shooting of the camera in the macro mode. Therefore, the mode switching of the lens assembly may enable the same camera to switch between the microscopic shooting mode and the macro shooting mode.

The camera in some embodiments of the present disclosure includes: an image sensor; and a lens assembly, which is configured to form an image on the image sensor. The lens assembly includes multiple lens groups, and the multiple lens groups are arranged along an optical axis of the lens assembly.

At least one of the multiple lens groups is movable relative to the image sensor to switch the lens assembly between a first mode and a second mode; a focusing object distance of the lens assembly in the first mode is less than a focusing object distance of the lens assembly in the second mode; the focusing object distance of the lens assembly in the first mode is less than 10 mm.

The electronic apparatus in some embodiments of the present disclosure includes the camera described in the above embodiments.

Additional aspects and advantages of the present disclosure will be provided in the following description, and in part will be obvious from the description or may be learned by practice of the present disclosure.

### BRIEF DESCRIPTION OF THE DRAWINGS

The above and/or additional aspects and advantages of the present disclosure will become apparent and readily understood from the description of the embodiments in conjunction with the following drawings.

FIG. 1 is a schematic plan view of a camera including two lens groups among which a first lens group is located at a first position, according to some embodiments of the present disclosure.

FIG. 2 is a schematic plan view of a camera including two lens groups among which a first lens group is located at a second position, according to some embodiments of the present disclosure.

FIG. 3 is a schematic plan view of a camera including three lens groups among which a first lens group is located at a first position, according to some embodiments of the present disclosure.

FIG. 4 is a schematic plan view of a camera including three lens groups among which a first lens group is located at a second position, according to some embodiments of the present disclosure.

FIG. 5 is a schematic structural view of a camera including two lens groups, according to some embodiments of the present disclosure.

FIG. 6 is a schematic structural view of a camera including three lens groups, according to some embodiments of the present disclosure.

FIG. 7 is a schematic plan view of an image sensor according to some embodiments of the present disclosure.

FIG. 8 is a schematic plan view of a flexible film layer, when bent, of an image sensor according to some embodiments of the present disclosure.

FIG. 9 is a schematic view of an image sensor receiving light when the lens is at a microscopic distance from an object according to some embodiments of the present disclosure.

FIG. 10 is a schematic structural view of a part of an image sensor according to some embodiments of the present disclosure.

FIG. 11 is a schematic structural view of another part of an image sensor according to some embodiments of the present disclosure.

FIG. 12 is a schematic plan view of a filter array according to some embodiments of the present disclosure.

FIG. 13 is a schematic plan view of a camera at a macro distance for shooting according to some embodiments of the present disclosure.

FIG. 14 is a schematic plan view of a camera at a microscopic distance for shooting according to some embodiments of the present disclosure.

FIG. 15 is a structural view of an electronic apparatus according to some embodiments of the present disclosure.

Description of main component symbols: electronic apparatus 1000; camera 100; image sensor 10; pixel array 11; flexible film layer 12; microlens array 121; driving device 13; piezoelectric device 131; support layer 14; filter array 141; red filter 1411; green filter 1412; blue filter 1413; flexible connector 15; lens assembly .20; lens group 21; first lens group 211; second lens group 212; third lens group 213; lens 22; light 30; detection element 40; driving apparatus 50; infrared filter 60; circuit board 70; object 2000.

### DETAILED DESCRIPTION

Embodiments of the present disclosure are described in detail below. Examples of which are illustrated in the accompanying drawings. The same or similar reference numerals throughout represent the same or similar elements or elements with the same or similar functions. The embodiments described below with reference to the drawings are exemplary and are only used to explain the present disclosure and cannot be understood as limiting the present disclosure.

The following disclosure provides many different embodiments or examples for implementing the various structures of the present disclosure. To simplify the disclosure of the present disclosure, the components and arrangements of specific examples are described below. They are merely examples and are not intended to limit the present disclosure. Further, the present disclosure may repeat reference numerals and/or reference letters in different examples. Such a repetition is for the purposes of simplicity and clarity and does not by itself indicate a relationship between the various embodiments and/or arrangements discussed. In addition, the present disclosure provides examples of various specific processes and materials, but people having ordinary skills in the art will recognize the present disclosure of other processes and/or the use of other materials.

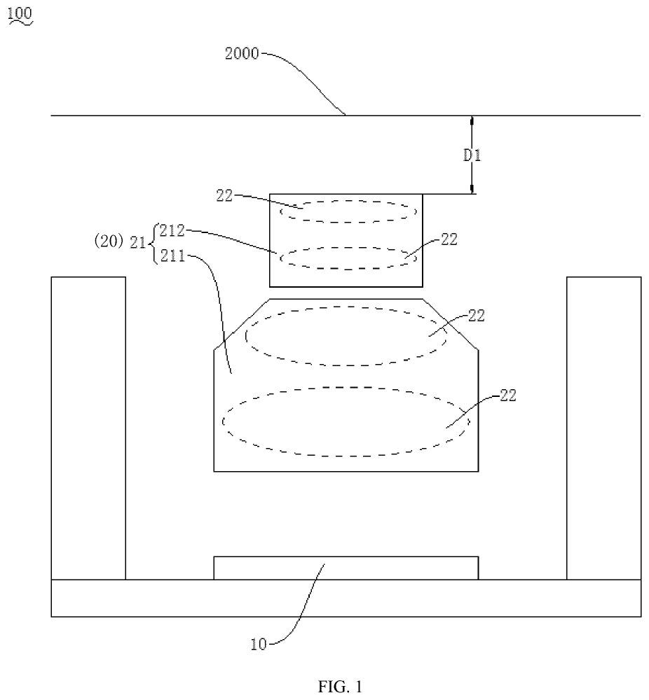

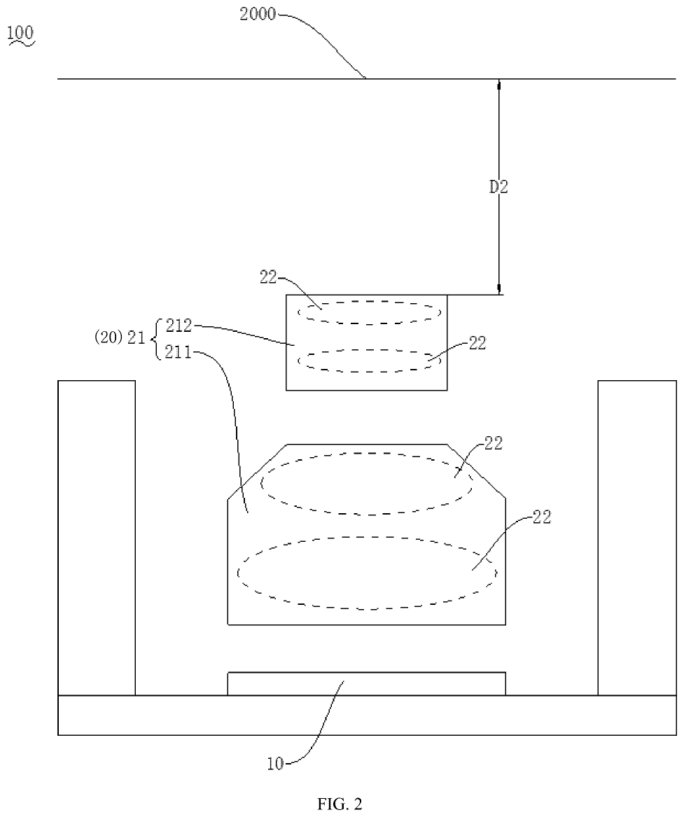

Referring to FIGS. 1 and 2, a camera 100 in the present disclosure includes an image sensor 10 and a lens assembly 20. The lens assembly 20 is configured to form an image on the image sensor 10. The lens assembly 20 includes multiple lens groups 21. The multiple lens groups 21 are arranged along an optical axis of the lens assembly 20.

At least one of the multiple lens groups 21 is movable relative to the image sensor 10 to switch the lens assembly 20 between a first mode and a second mode. A focusing object distance of the lens assembly 20 in the first mode is less than that in the second mode. In condition of the lens assembly 20 being in the first mode, the focusing object distance is less than 10 mm.

Referring to FIGS. 1 and 2, in some embodiments, each lens group 21 includes at least one lens 22.

In some embodiments, a total number of the lenses 22 in the lens assembly 20 is 4 or 5.

Referring to FIGS. 1, 2, and 5, in some embodiments, the multiple lens groups 21 include a first lens group 211 and a second lens group 212. The first lens group 211 is arranged between the image sensor 10 and the second lens group 212. The first lens group 211 is movable relative to the image sensor 10.

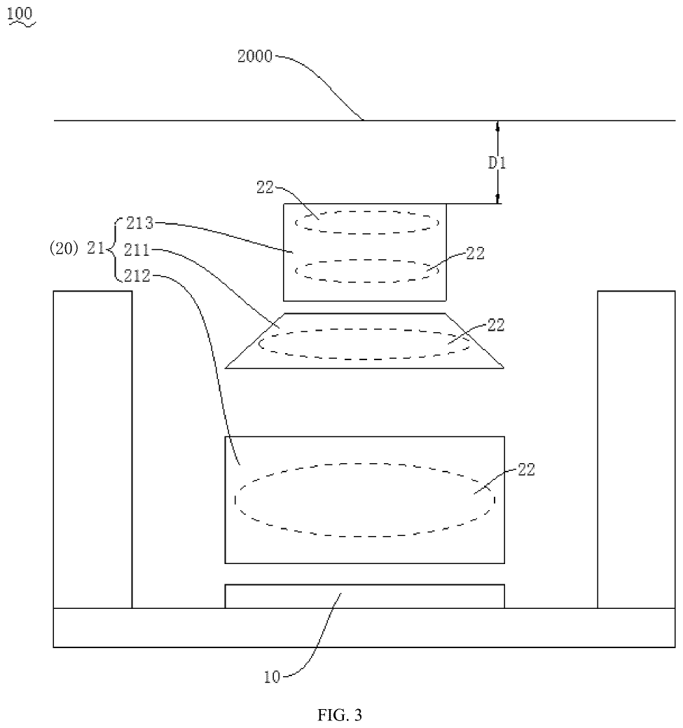

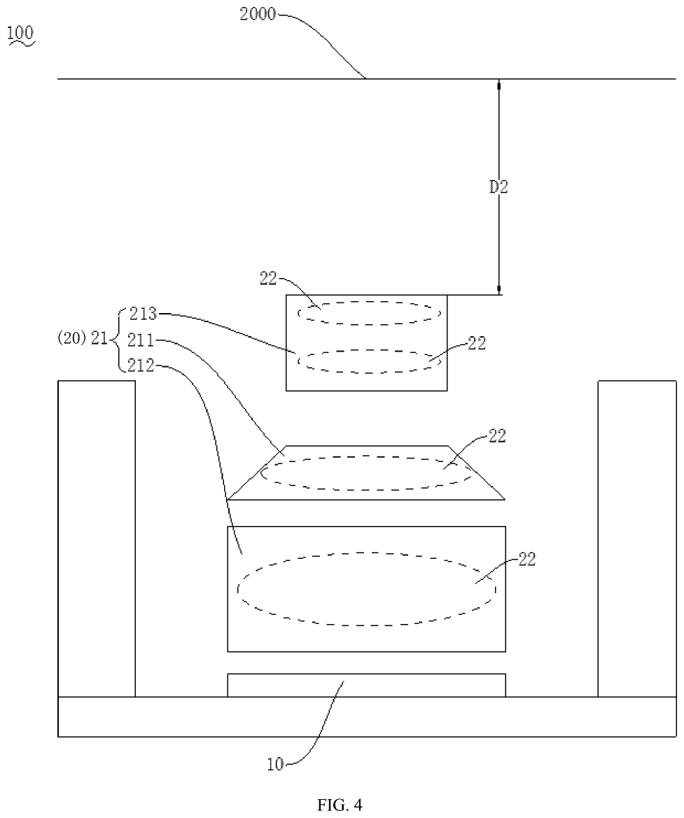

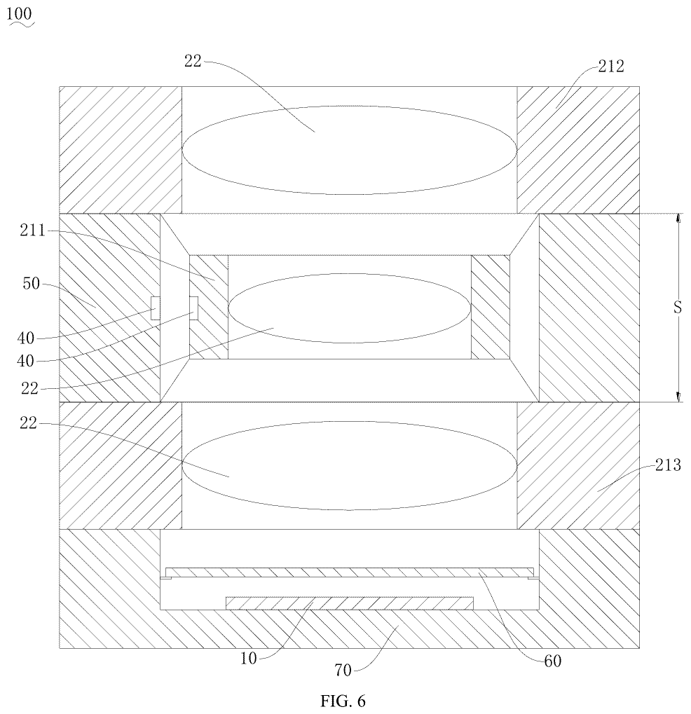

Referring to FIGS. 3, 4, and 6, in some embodiments, the multiple lens groups 21 include a first lens group 211, a second lens group 212, and a third lens group 213. The first lens group 211 is arranged between the second lens group 212 and the third lens group 213. As shown in FIGS. 3 and 4, the third lens group 213 is arranged farther away from the image sensor 10 relative to the second lens group 212. As shown in FIG. 6, the third lens group 213 is arranged closer to the image sensor 10 relative to the second lens group 212.

Referring to FIGS. 1-4, in some embodiments, the first lens group 211 has a first position and a second position. In condition of the first lens group 211 being in the first position, the first lens group 211 is closer to the second lens group 212 than in condition of the first lens group being in the second position.

In condition of the first lens group 211 being in the first position, the lens assembly 20 is in the first mode. In condition of the first lens group 211 being in the second position, the lens assembly 20 is in the second mode.

Referring to FIGS. 1-4, in some embodiments, the first lens group 211 has a first position and a second position. In condition of the first lens group 211 being in the first position, the first lens group 211 is closer to the second lens group 212 than in condition of the first lens group being in the second position. In condition of the first lens group 211 being in the first position, the lens assembly 20 is in the second mode. In condition of the first lens group 211 is in the second position, the lens assembly 20 is in the first mode.

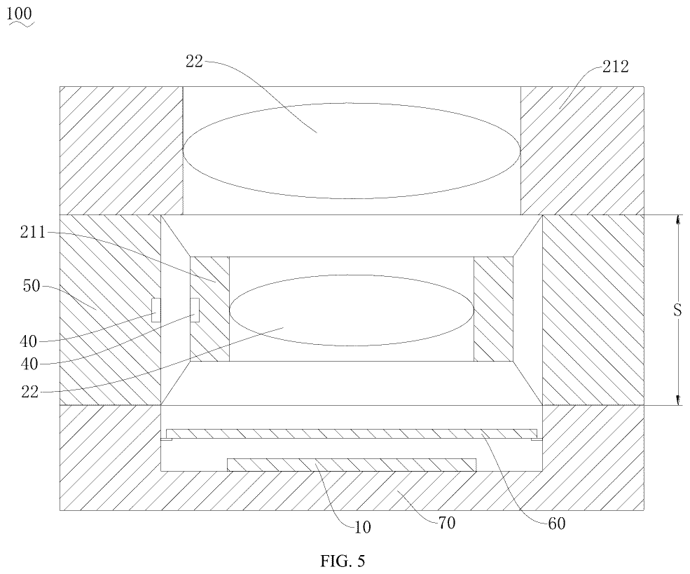

Referring to FIGS. 5 and 6, in some embodiments, the camera 100 includes a detection element 40 arranged on the first lens group 211. The detection element 40 is configured to detect the position of the first lens group 211.

In some embodiments, the detection element 40 includes at least one of a Hall element, a magnet, and a coil.

In some embodiments, the moving distance S of the first lens group 211 ranges from 300 μm to 1500 μm.

Referring to FIGS. 2 and 4, in some embodiments, the focusing object distance of the lens assembly 20 in the second mode is less than or equal to 30 mm.

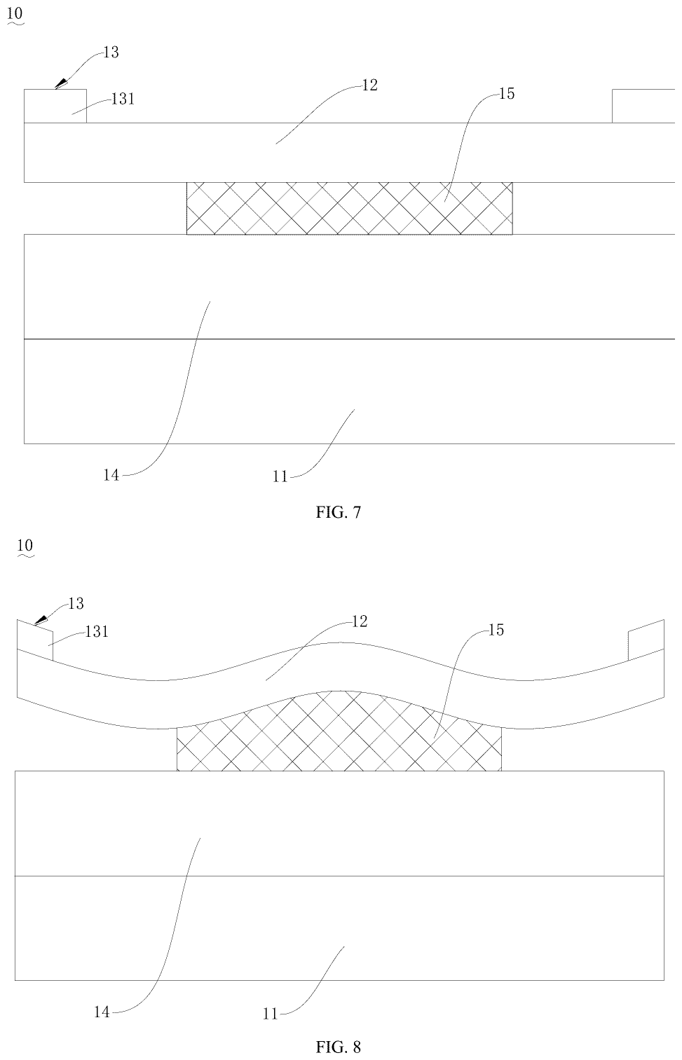

Referring to FIGS. 7 and 8, in some embodiments, the image sensor 10 includes a pixel array 11, a flexible film layer 12 that is light-transmissive, and a driving device 13. The flexible film layer 12 and the pixel array 11 are stacked. The driving device 13 is arranged on the flexible film layer 12. The driving device 13 may change a curvature of the flexible film layer 12 to correct a field curvature of the lens assembly 20.

In some embodiments, the driving device 13 includes a piezoelectric device 131. In condition of a voltage being applied to the piezoelectric device 131, the piezoelectric device 131 deforms to drive the flexible film layer 12 to deform.

In some embodiments, the piezoelectric device 131 may be a piezoelectric thin film.

Referring to FIGS. 7 and 8, in some embodiments, the piezoelectric device 131 is arranged at an edge position of the flexible film layer 12.

Referring to FIG. 10, in some embodiments, a microlens array 121 is formed on the flexible film layer 12. The microlens array 121 is configured to focus light toward the pixel array 11.

Referring to FIG. 10, in some embodiments, the microlens array 121 is formed on the surface of the flexible film layer 12 away from the pixel array 11.

Referring to FIGS. 1 and 2, the camera 100 in the present disclosure includes the image sensor 10 and the lens assembly 20. The lens assembly 20 is configured to form an image on the image sensor 10. The camera assembly 20 includes multiple lens groups 21. The multiple lens groups 21 are arranged along an optical axis of the lens assembly 20.

At least one of the multiple lens groups 21 is movable relative to the image sensor 10 to switch the lens assembly 20 between a first mode and a second mode. The focusing object distance of the lens assembly 20 in the first mode is less than that in the second mode. In condition of the lens assembly being in the first mode, the focusing object distance is less than 10 mm.

The camera 100 in the above embodiments of the present disclosure can switch the lens assembly 20 between the first mode and the second mode through the movement of the lens group 21 relative to the image sensor 10. The first mode may correspond to the shooting of the camera 100 in the microscopic mode. The second mode may correspond to the shooting of the camera 100 in the macro mode. Therefore, the mode switching of the lens assembly 20 may enable the same camera 100 to switch between the microscopic shooting mode and the macro shooting mode, which increases the diversity of usage scenarios of the camera 100.

In some embodiments, the image sensor 10 may be a photosensitive element arranged in the camera 100, and the image sensor 10 may convert an optical signal into an electrical signal. The image sensor 10 may be arranged inside the camera 10 and below the lens assembly 20.

The lens assembly 20 may have multiple lens groups 21, and the multiple lens groups 21 are arranged along the optical axis direction of the lens assembly 20. The optical axis direction may be an axis along which the light beam passes through a centre of the lens assembly 20. The multiple lens groups 21 may be in an independent state. At least one of the multiple lens group 21 is movable along the optical axis direction relative to the image sensor 10. The movement of the lens group 21 may change the focusing object distance of the lens assembly 20, thus enabling the lens 20 to switch between the first mode and the second mode.

The first mode may be a distance D1 between the lens assembly 20 and the object 2000, which is a microscopic distance less than 10 mm. For example, D1 may be a microscopic distance of 5 mm. In this case, the focusing object distance achieved by the lens assembly 20 is also less than 10 mm, enabling the object 2000 at a microscopic distance from the lens assembly 20 to form an image on the image sensor 10 clearly through the lens assembly 20.

Further, the second mode may be a distance D2 between the lens assembly 20 and the object 2000, which is greater than 10 mm. For example, D2 may be a macro distance of 30 mm. In this case, the focusing object distance achieved by the lens assembly 20 is also greater than 10 mm, enabling the object 2000 at a macro distance from the lens assembly 20 to form an image on the image sensor 10 clearly through the lens assembly 20.

Referring to FIGS. 1 and 2, in some embodiments, each lens group 21 includes at least one lens 22.

In this way, the at least one lens 22 of each lens group 21 are combined in the multiple lens groups 21, enabling the multiple lens groups 21 to achieve the transformation of the focusing object distance of the lens assembly 20 by means of the multiple lenses 22.

In some embodiments, the lens 22 may be a convex lens or a concave lens. One or more lenses 22 may be packaged together in a single lens group 21. The number of lenses 22 in different lens groups 21 may be different.

In some embodiments, the total number of lenses 22 in the lens assembly 20 is 4 or 5.

In this way, the total number of lenses 22 in the lens assembly 20 is 4 or 5 can ensure that there are enough lenses 22 in the multiple lens groups 21 to achieve the switching of the focusing object distance.

In some embodiments, the total number of lenses 22 of the lens assembly 20 may be the total number of lenses 22 in the multiple lens groups 21 in the lens assembly 20. Each of the multiple lens groups 21 includes at least one lens 22. In condition of the total number of lenses 22 of the lens assembly 20 being 4 or 5, the lenses 22 in the multiple lens groups 21 may be combined in different ways to achieve that the total number of the lenses 22 in the multiple lens groups 21 is 4 or 5.

For example, in condition of the number of lens groups 21 in the lens assembly 20 being 2, one of the two lens groups 21 may have two lenses 22, and the other lens group 21 may also have two lenses 22. Therefore, the total number of lenses 22 in the lens assembly 20 may be 4. Similarly, the combination of the two lens groups 21 may be in a combination mode such as “1+3” or “3+1”.

It can be understood that the number of numbers in the quotation marks of “1+3” may represent the number of lens groups, and the sum of the numbers may represent the total number of lenses 22. Therefore, the two numbers within the quotation marks of “1+3” may indicate that there are two lens groups. The sum of the numbers being 4 may indicate that the total number of lenses 22 is 4. The meaning of the number “1” may indicate that the number of lenses 22 in one of the two lens groups is 1. The meaning of the number “3” may indicate that the number of lenses 22 in the other of the two lens groups is 3. Other combinations may be derived from here similarly.

Furthermore, in condition of the total number of lenses 22 in the lens assembly 20 being 5, the combination of the two lens groups 21 may be in a combination mode such as “2+3” or “3+2”. It should be understood that the number of lens groups 21 and the total number of lenses 22 may also be combined differently and combined with different numbers of lenses 22 in a single lens group 21. For example, in condition of the total number of lenses 22 in three lens groups 21 being 4, the combination mode may be “1+1+2”, or in condition of the total number of lenses 22 in four lens groups 21 being 5, the combination mode may be “2+1+1+1”, etc. No specific restrictions are intended to be made here.

Referring to FIGS. 1, 2, and 5, in some embodiments, the lens groups 21 include the first lens group 211 and the second lens group 212. The first lens group 211 is arranged between the image sensor 10 and the second lens group 212. The first lens group 211 is movable relative to the image sensor 10.

In this way, the focusing object distance of the lens groups 21 may be changed by moving the first lens group 211, enabling the lens assembly 20 to switch to the first mode or the second mode.

In some embodiments, the second lens group 212 and the first lens group 211 may be arranged in an up-and-down order along the optical axis direction of the lens group 21. The second lens group 212 may be arranged at the upper part, and the second lens group 212 may be closer to a plane of the object 2000, and farther away from the image sensor 10 relative to the first lens group 211. There is a distance between the second lens group 212 and the image sensor 10, and the first lens group 211 may be arranged between the second lens group 212 and the image sensor 10. The relative distance between the second lens group 212 and the image sensor 10 may remain unchanged, and the first lens group 211 is movable between the second lens group 212 and the image sensor 10 driven by a driving apparatus 50. The moving direction of the first lens group 211 may be moving closer to or farther away from the image sensor 10, thus enabling the lens assembly 20 to switch to the first mode or the second mode.

Referring to FIGS. 3, 4, and 6, in some embodiments, the multiple lens groups 21 include the first lens group 211, the second lens group 212, and the third lens group 213. As shown in FIGS. 3 and 4, the third lens group 213 is arranged farther away from the image sensor 10 relative to the second lens group 212. As shown in FIG. 6, the third lens group 213 is arranged closer to the image sensor 10 relative to the second lens group 212.

In this way, the focusing object distance of the lens group 21 may be changed by moving the first lens group 211, enabling the lens assembly 20 to switch to the first mode or the second mode.

In some embodiments, the second lens group 212, the first lens group 211, and the third lens group 213 may be arranged in an up-and-down order along the optical axis direction of the lens group 21. The second lens group 212 may be arranged at the upper part, and the second lens group 212 may be closer to the plane of the object 2000, and farther away from the image sensor 10 relative to the first lens group 211. The third lens group 213 may be closer to the image sensor 10 and farther away from the plane of the object 2000 relative to the first lens group 211. There is a distance between the second lens group 212 and the third lens group 213, and the first lens group 211 may be arranged between the second lens group 212 and the third lens group 213. The relative distance between the second lens group 212 and the third lens group 213 may remain unchanged. The relative distance between the third lens group 213 and the image sensor 10 may remain unchanged.

The first lens group 211 is movable between the second lens group 212 and the third lens group 213 driven by the driving apparatus 50. The moving direction of the first lens group 211 may be moving closer to or farther away from the image sensor 10, thus enabling the lens assembly 20 to switch to the first mode or the second mode.

Referring to FIGS. 1-4, in some embodiments, the first lens group 211 has a first position and a second position. In condition of the first lens group 211 being in the first position, the first lens group 211 is closer to the second lens group 212 than in condition of the first lens group being in the second position.

In condition of the first lens group 211 being in the first position, the lens assembly 20 is in the first mode. In condition of the first lens group 211 being in the second position, the lens assembly 20 is in the second mode.

In condition of the first lens group 211 being in the first position, the lens assembly 20 is in the second mode. In condition of the first lens group 211 being in the second position, the lens assembly 20 is in the first mode.

In this way, in condition of the first lens group 211 being in either the first position or the second position, the lens assembly 20 may be in either the first mode or the second mode, enabling the first lens group 211 to move to the corresponding position which may have a corresponding mode of the lens assembly 20.

In some embodiments, in condition of the first lens group 211 being in the first position (as shown in FIGS. 1 and 3), the first lens group 211 is closer to the second lens group 212 than in condition of the first lens group 211 being in the second position (as shown in FIGS. 2 and 4). When the lens assembly 20 is in the switching process of switching from the first mode to the second mode, the mode switching of the lens assembly 20 may be achieved by arranging the first lens group 211 in different positions. The first position of the first lens group 211 may be a position where the first lens group 211 is closer to the second lens group 212 within the movement range of the first lens group 211. In this case, the overall focusing object distance of the lens group 21 may be a micro distance less than 10 mm. The lens assembly 20 may be in the first mode. The second position of the first lens group 211 may be a position where the first lens group 211 is closer to the image sensor 10 within the movement range of the first lens group 211. In this case, the overall focusing object distance of the lens group 21 may be a macro distance greater than 10 mm. The lens assembly 20 may be in the second mode.

As the focusing object distance of the lens group 21 at different positions depends on the distribution design of the focal length of the lens group 21, it may also be that, in condition of the first lens group 211 being in the first position, the overall focusing object distance of the lens group 21 may be a macro distance greater than 10 mm and the lens assembly 20 is in the second mode. In condition of the first lens group 211 being in the second position, the overall focusing object distance of the lens group 21 may be a microscopic distance less than 10 mm and the lens assembly 20 is in the first mode.

It should be understood that, when the first lens group 211 switches between the first position and the second position, the overall focusing object distance of the lens group 21 may be changed intermittently or continuously. For example, when the first lens group 211 switches between the first position and the second position, the focusing object distance of the lens assembly 20 may be changed gradually from 30 mm to 5 mm, which is an intermittent change. Alternatively, when the first lens group 211 switches between the first position and the second position, the focusing object distance of the lens assembly 20 may gradually switch from 30 mm to 5 mm, which is a continuous change.

Referring to FIGS. 5 and 6, in some embodiments, the camera 100 includes the detection element 40 arranged on the first lens group 211. The detection element 40 is configured to detect the position of the first lens group 211.

In this way, the detection element 40 arranged on the first lens group 211 may detect the position of the first lens group 211, enabling the camera 100 to determine whether the lens assembly 20 is in the first mode or the second mode based on the detected position.

In some embodiments, modular components such as the first lens group 211, the second lens group 212, and the image sensor 10 in the camera 100 are fixedly connected to each other and the connection method may be bonding with glue. Each component in the camera 100 may be connected to each other from top to bottom. An upper layer may be the second lens group 212. What is connected to the second lens group 212 and arranged below the second lens group 212 may be the first lens group 211 and the driving apparatus 50. The driving apparatus 50 may drive the first lens group 211 to move towards or away from the second lens group 212, such as a motor. The driving apparatus 50 may also drive the first lens group 211 to translate to achieve the anti-shake function of the lens assembly 20. The bottom may be a circuit board 70 and the image sensor 10. The image sensor 10 may be arranged on a surface of the circuit board 70 facing the first lens group 211. An infrared filter 60 may also be arranged between the image sensor 10 and the first lens group 211.

The detection element 40 may be arranged on the first lens group 211. The detection element 40 includes at least one of a Hall element, a magnet, and a coil. The detection element 40 may be arranged in pairs on the first lens group 211 and the driving apparatus 50. For example, a Hall element is arranged on a side of the first lens group 211, and a magnet or coil is arranged on the corresponding driving apparatus 50. Then, the detection element 40 arranged on the first lens group 211 may detect the position of the first lens group 211 by performing magnetic detection or photoelectric detection with the detection element 40 paired with the driving apparatus 50 that drives the first lens group 211.

For example, when a Hall element is used as the detection element 40 on the first lens group 211 and a motor is used as the driving apparatus 50 to drive the first lens group 211, another detection element 40 such as a magnet or the like, may be arranged on the motor. The position of the first lens group 211 is then determined based on the magnetic field induced by the Hall element.

Referring to FIGS. 5 and 6, in some embodiments, the moving distance S of the first lens group 211 ranges from 300 μm to 1500 μm.

In this way, the moving distance S of the first lens group 211 ranges from 300 μm to 1500 μm, which may better meet the change of the focusing object distance of the lens assembly 20 between the first mode and the second mode.

In some embodiments, the range of the moving distance S of the first lens group 211 may be the distance between an upper surface of the first lens group 211 in condition of the first lens group 211 being in the first position and the upper surface of the first lens group 211 in condition of the first lens group 211 being in the second position. A value of the range of the moving distance S may depend on a focal length of the lens group 21, and the value of S may be substantially in a range from 300 μm to 1500 μm.

Referring to FIGS. 2 and 4, in some embodiments, the focusing object distance of the lens assembly 20 in the second mode is less than or equal to 30 mm.

In this way, the lens assembly 20 in the second mode may realize the microscopic shooting distance of the camera 100.

In some embodiments, the focusing object length of the lens assembly 20 in the second mode is greater than that in the first mode (i.e. 10 mm) and less than or equal to 30 mm, which may correspond to the shooting state of the camera 100 when the distance between the camera 100 and the object 2000 is at a macro distance. Therefore, the lens assembly 20 may achieve macro distance focusing, and when the camera 100 and the object 2000 are at a macro distance, a clear image may be formed on the image sensor 10.

Referring to FIGS. 7 and 8, in some embodiments, the image sensor 10 includes the pixel array 11, the flexible film layer 12 that is light-transmissive, and the driving device 13. The flexible film layer 12 and the pixel array 11 are stacked. The driving device 13 is arranged on the flexible film layer 12. The driving device 13 may change the curvature of the flexible film layer 12 to correct the field curvature of the lens assembly 20.

In this way, the image sensor 10 includes the flexible film layer 12 with the curvature that is variable. The image sensor 10 may use the driving device 13 to change the curvature of the flexible film layer 12, which in turn may change the curvature of the image sensor 10. The change in curvature of the image sensor 10 may correct the field curvature generated by the lens assembly 20 during microscopic shooting, enabling a clear image to be formed.

In some embodiments, the image sensor 10 may be a photosensitive element used in the electronic apparatus with shooting functions such as a mobile phone and a digital camera. The image sensor 10 may convert an optical signal into an electrical signal. The pixel array 11 may be an area in the image sensor 10 for sensing light and performing photoelectric conversion. The pixel array 11 may be stacked up and down with the flexible film layer 12, and the pixel array 11 may be arranged below the flexible film layer 12. The flexible film layer 12 may be a thin film layer that is flexible and may be made of glasses or other materials. The thickness of the flexible film layer 12 may be 5 μm.

The driving device 13 may be a device that drives the flexible film layer 12 to bend through its own deformation, thus changing the curvature of the flexible film layer 12. The driving device 13 may be arranged on the flexible film layer 12. For example, the driving device 13 may be arranged on a surface of the flexible film layer 12 away from the pixel array 11.

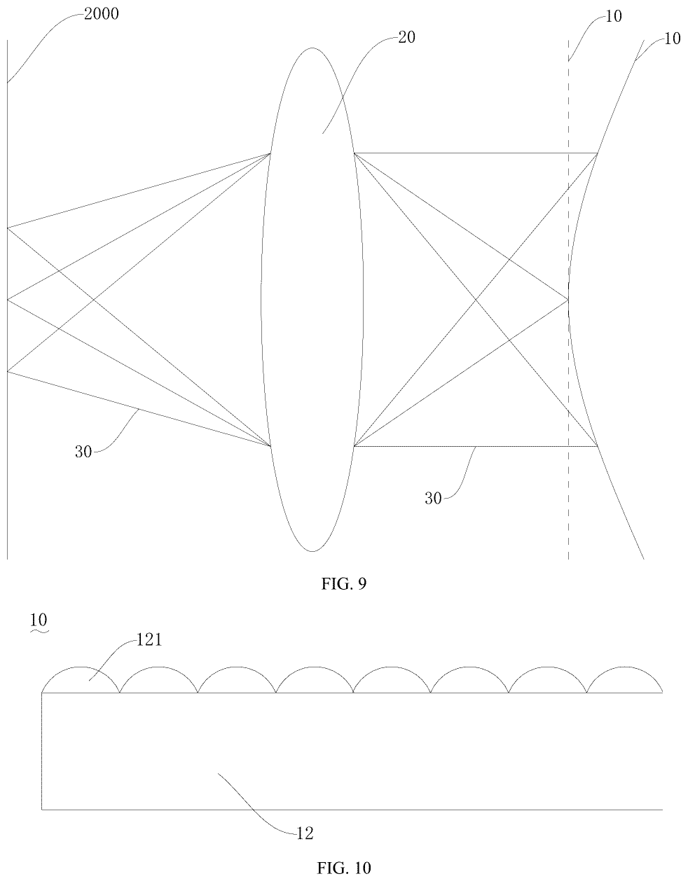

It may be further illustrated by FIG. 9 that in condition of the distance between the lens assembly 20 and the plane of the object 2000 being at a microscopic distance, for example, in condition of the distance being 5 mm, the light 30 emitted by the object 2000 is focused on the image sensor 10 through the lens assembly 20. Due to the field curvature generated by the lens assembly 20, part of the light 30 passes through the lens assembly 20 and is focused on an unbent rear side of the image sensor 10 of the flexible film layer 12, causing the image to be blurred. In this case, the driving device 13 may drive the flexible film layer 12 to bend, which in turn may change the curvature of the image sensor 10. After the curvature of the image sensor 10 is changed, all the light 30 emitted by the object 2000 may be focused on the image sensor 10, thus solving the problem of the image being blurred, enabling the image to be clear.

Referring to FIGS. 7 and 8, in some embodiments, the driving device 13 includes the piezoelectric device 131. In condition of a voltage being applied to the piezoelectric device 131, the piezoelectric device 131 deforms to drive the flexible film layer 12 to deform.

In this way, applying a voltage may quickly control the piezoelectric device 131 to deform, increasing the deformation speed of the flexible film layer 12, and thus increasing the correction speed of the image sensor 10 for the field curvature of the lens assembly 20.

In some embodiments, the piezoelectric device 131 may be a piezoelectric actuator. For example, the piezoelectric device 131 may be a piezoelectric thin film and may realize its own deformation through the technology of thin film piezoelectricity. For example, in condition of the voltage of 0 V being applied to the piezoelectric device 131, the piezoelectric device 131 itself does not change, and the flexible film layer 12 does not deform (as shown in FIG. 7). In condition of the voltage of 40 V being applied to the piezoelectric device 131, the piezoelectric device 131 deforms and drives the flexible film layer 12 to deform, which in turn may cause the flexible film layer 12 to deform. The deformation of the flexible film layer 12 may cause the middle region of the flexible film layer 12 to be convex (as shown in FIG. 8) as compared to an undeformed state.

Referring to FIGS. 7 and 8, in some embodiments, the piezoelectric device 131 is arranged at the edge position of the flexible film layer 12.

In this way, the piezoelectric device 131 arranged at the edge position of the flexible film layer 12 may not block the light transmittance in the middle of the flexible film layer 12, so that the amount of light transmitted through the flexible film layer 12 and contacting the pixel array 11 is normal.

In some embodiments, the piezoelectric device 131 may be arranged on an outer edge side of the flexible film layer 12, and the piezoelectric device 131 may be connected to the flexible film layer 12 around an outer edge position of the flexible film layer 12.

Referring to FIG. 10, in some embodiments, the microlens array 121 is formed on the flexible film layer 12. The microlens array 121 is configured to focus light toward the pixel array 11.

In this way, the microlens array 121 is arranged on the flexible film layer 12 to focus light toward the pixel array 11, which may increase a fill factor of the pixel array 11, thus improving the imaging effect of the image sensor 10.

In some embodiments, the microlens array 121 includes multiple sub-lenses. The multiple sub-lens may be arranged in an array, and the diameters of the multiple sub-lenses may be at a nanoscale or millimeter level. The microlens array 121 may achieve parallel refractive focusing through sub-lenses.

Referring to FIG. 10, in some embodiments, the microlens array 121 is formed on the surface of the flexible film layer 12 away from the pixel array 11. In this way, the arrangement of the microlens array 121 may enable a focused light path direction to illuminate toward the pixel array 11.

In some embodiments, the microlens array 121 may be arranged on a side of the flexible film layer 12 away from the pixel array 11. A convex surface of the sub-lenses on the microlens array 121 may be convex upward away from the flexible film layer 12, enabling the microlens array 121 to have an effect of focusing light.

Referring to FIGS. 7 and 8, in some embodiments, the image sensor 10 further includes a support layer 14 and a flexible connector 15. The support layer 14 is arranged on the pixel array 11. The flexible connector 15 connects the flexible film layer 12 and the support layer 14. The flexible connector 15 deforms following the deformation of the flexible film layer 12.

In this way, the support layer 14 may support the flexible connector 15. The flexible connector 15 follows the deformation of the flexible film layer 12 and generates the corresponding deformation to achieve corresponding changes in the focusing position of the light, enabling the image sensor 10 to have the capacity to focus automatically.

In some embodiments, the support layer 14 may be arranged above the pixel array 11. The support layer 14 may be a structural layer made of glass materials with a supporting function. One end of the flexible connector 15 may be connected to the support layer 14, and an end away from the support layer 14 may be connected to the flexible film layer 12. The flexible connector 15 may be a polymer formed of a high molecular structure and may deform itself following the deformation of the flexible film layer 12.

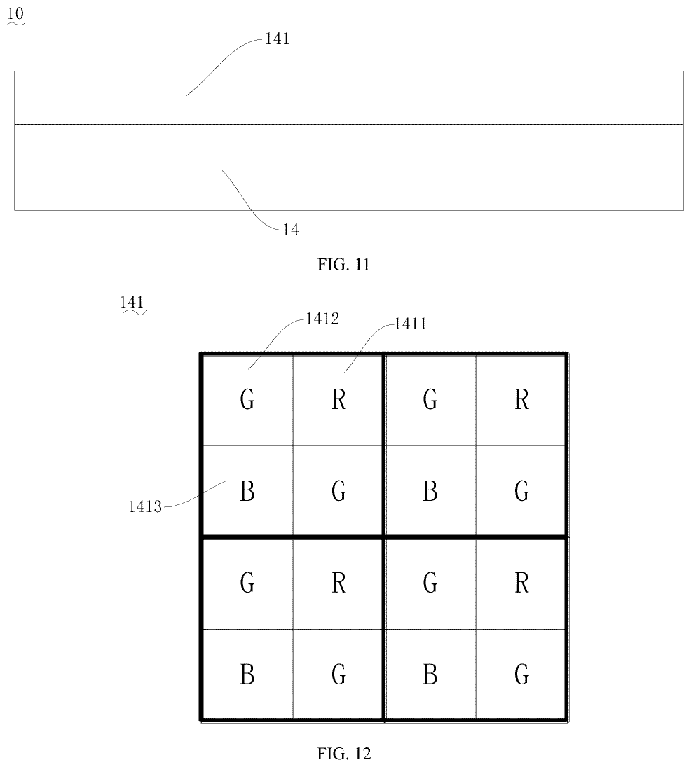

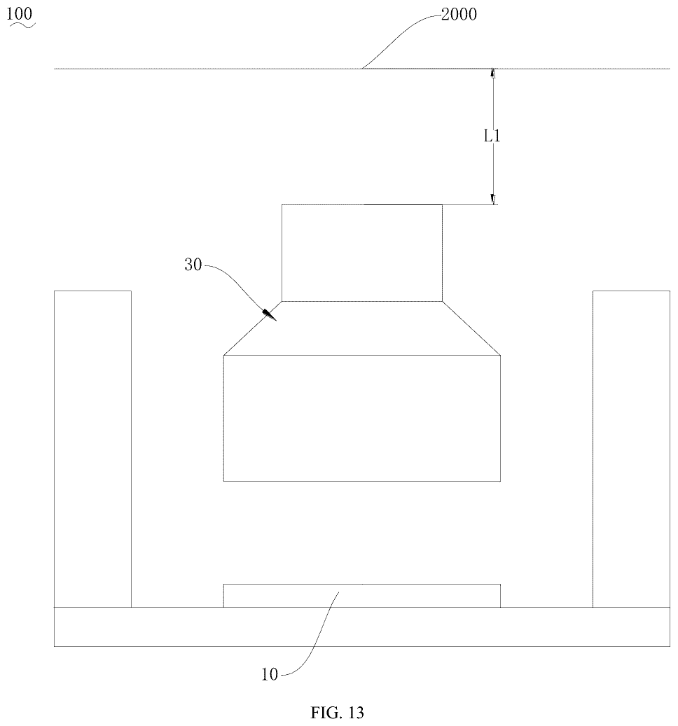

Referring to FIGS. 11 and 12, in some embodiments, the support layer 14 is formed with a filter array 141. The filter array 141 includes a red filter 1411, a green filter 1412, and a blue filter 1413.

In this way, the filter array 141 formed on the support layer 14 may filter a color of light entering the pixel array 11. Since the pixel array 11 cannot distinguish the color of light, thus, setting the filter array 141 may help the pixel array 11 distinguish the color of light.

In some embodiments, the filter array 141 may be understood as an array that filters a wavelength of light of different colors. The filter array 141 may filter the light entering the pixel array 11 in separate channels. It may be understood that the filter array 141 is equivalent to modulating the incident signal, and the commonly used modulation mode is a Bayer array. The filter array 141 may include a red filter 1411, a green filter 1412, and a blue filter 1413. As shown in FIG. 11, when the filter array 141 adopted is a Bayer array, it includes three channels: red (R), green (G), and blue (B). R may represent the red filter 1411, G may represent the green filter 1412, and B may represent the blue filter 1413. Densities of the three channels R, G, and B may be ¼, ½, and ⅓ respectively. After being modulated by the filter array 141, the light can be incident on the pixel array 11 for photoelectric conversion and analog-to-digital conversion.

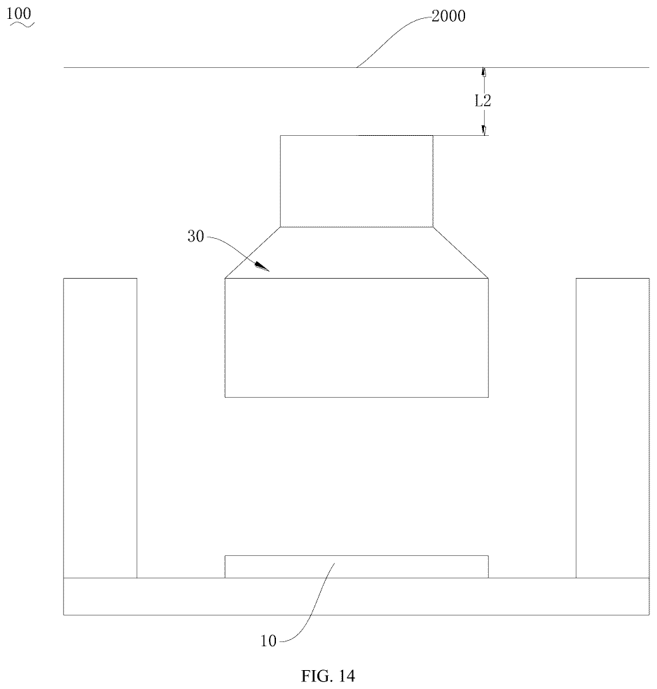

Referring to FIGS. 13 and 14, the camera 100 in some embodiments of the present disclosure includes the image sensor 10 and the lens assembly 20 of the above embodiments, and the lens assembly 20 is configured to form an image on the image sensor 10.

The camera 100 in some embodiments of the present disclosure may achieve clear shooting of the object 2000 at a microscopic distance by imaging the image on the image sensor 10 through the lens assembly 20. The image sensor 10 may correct the field curvature generated by the lens assembly 20 when the lens assembly 20 is at a microscopic distance from the object 2000, enabling the image captured by the camera 100 to be clear.

In some embodiments, the camera 100 may be a camera 100 with multiple shooting functions such as macro shooting and microscopic shooting. The lens assembly 20 may be an optical element composed of a glass lens. The lens assembly 20 may be arranged above the image sensor 10. The lens assembly 20 may collect a scene image that the camera 100 needs to capture and transfer it to the image sensor 10 for imaging.

Referring to FIGS. 13 and 14, in some embodiments, the lens assembly 20 may move along the optical axis of the lens assembly 20 relative to the image sensor 10 to change the shooting mode of the camera 100.

In this way, by moving the lens assembly 20 relative to the image sensor 10, the camera 100 may adjust the shooting modes under different object distances. Therefore, the camera 100 may improve the shooting effect in different modes after adjustment.

In some embodiments, the lens assembly 20 is arranged above the image sensor 10. The lens assembly 20 may face the image sensor 10. The lens assembly 20 may connect to a power device such as a motor. The power device may be used to drive the lens assembly 20 to move along the optical axis direction. The direction of the optical axis may be a direction of a central axis of the lens assembly 20 that receives light.

For example, as shown in FIG. 13, the distance between the object 2000 being shot and an upper surface of the lens assembly 20 is L1. L1 may be a macro distance. For example, when the distance L1 between the lens assembly 20 and the object 2000 being shot is 30 mm, the distance L1 may be viewed as a macro distance. As shown in FIG. 14, when the camera 100 needs to switch the shooting mode to the microscopic mode or the distance L2 between the shot object 2000 and the upper surface of the lens assembly 20 is less than the macro distance L1, for example, the distance L2 between the lens assembly 20 and the shot object 2000 is at a microscopic distance of 5 mm, the lens assembly 20 may be driven by the motor to move relative to the image sensor 10 along the optical axis in a direction away from the image sensor 10. For example, the distance the lens assembly 20 moves away may be 840 mm. In this case, the field curvature of the outer field of view of the lens assembly 20 is relatively large, and the field curvature of the edge field of the view may be close to 30 μm.

Referring to FIG. 9, the image sensor 10 changes the curvature accordingly so that the image captured by the lens assembly 20 may form a clear image on the image sensor 10.

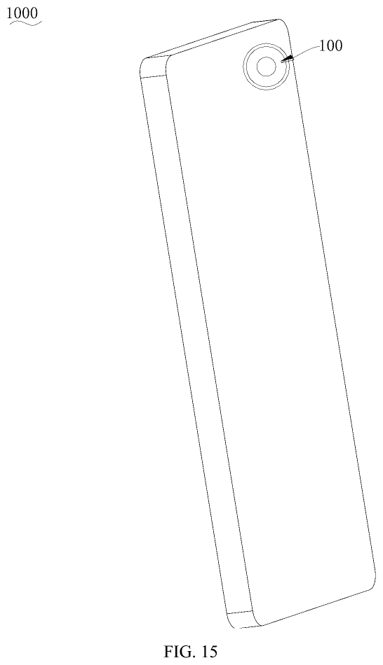

Referring to FIG. 15, the electronic apparatus according to some embodiments of the present disclosure includes a camera. The camera is the camera according to the above embodiments.

By being provided with a camera 100, the electronic apparatus 1000 in some embodiments of the present disclosure may achieve the macro distance shooting and the micro distance shooting on a single camera, and improve the imaging effect of the electronic apparatus 1000 under the micro distance shooting.

In some embodiments, the electronic apparatus 1000 may be a terminal device with a camera function. For example, the electronic apparatus 1000 may include a smartphone, a tablet, a computer, a digital camera, or other terminal equipment with a camera function. The camera 100 may be arranged on the electronic apparatus 1000, such as a rear camera of a mobile phone, a camera of a digital camera, etc. The camera 100 is configured to achieve the microscopic shooting and macro shooting functions of the electronic apparatus 1000 at the same time.

In the description of this specification, reference to the terms “one embodiment”, “certain embodiments”, “illustrative embodiments”, “examples”, “specific examples”, or “some examples” means that specific features, structures, materials, or characteristics described in conjunction with the embodiments or examples are included in at least one embodiment or example of the present disclosure. In this specification, schematic expressions of the above terms do not necessarily refer to the same embodiments or examples. Moreover, the specific features, structures, materials, or characteristics described may be combined in any one or more of the embodiments or examples in a suitable manner.

Although the embodiments of the present disclosure have been shown and described, it will be understood by those skilled in the art that a variety of changes, modifications, substitutions, and variations of these embodiments may be made without departing from the principles and purposes of the present disclosure, the scope of which is limited by the claims and their equivalents.

What is claimed is:

1. A camera, comprising:
an image sensor; and
a lens assembly, wherein the lens assembly is configured to form an image on the image sensor; the lens assembly comprises a plurality of lens groups, and the plurality of lens groups are arranged along an optical axis of the lens assembly;
wherein at least one of the plurality of lens groups is movable relative to the image sensor to switch the lens assembly between a first mode and a second mode; a focusing object distance of the lens assembly in the first mode is less than a focusing object distance of the lens assembly in the second mode; the focusing object distance of the lens assembly in the first mode is less than 10 mm.

2. The camera according to claim 1, wherein each lens group comprises a lens.

3. The camera according to claim 2, wherein a total number of the lenses in the lens assembly is 4 or 5.

4. The camera according to claim 1, wherein the plurality of lens groups comprises a first lens group and a second lens group; the first lens group is arranged between the image sensor and the second lens group, and the first lens group is movable relative to the image sensor.

5. The camera according to claim 1, wherein the plurality of lens groups comprises a first lens group, a second lens group, and a third lens group; the first lens group is arranged between the second lens group and the third lens group, and the third lens group is arranged farther away from the image sensor relative to the second lens group.

6. The camera according to claim 4, wherein the first lens group has a first position and a second position; the first lens group in condition of being in the first position is closer to the second lens group than in condition of being in the second position;
in condition of the first lens group being in the first position, the lens assembly is in the first mode; in condition of the first lens group being in the second position, the lens assembly is in the second mode.

7. The camera according to claim 4, wherein the first lens group has a first position and a second position, in condition of the first lens group being in the first position, the first lens group is closer to the second lens group;
in condition of the first lens group being in the first position, the lens assembly is in the second mode; in condition of the first lens group being in the second position, the lens assembly is in the first mode.

8. The camera according to claim 4, wherein the camera further comprises a detection element arranged on the first lens group, and the detection element is configured to detect a position of the first lens group.

9. The camera according to claim 8, wherein the detection element comprises at least one of a Hall element, a magnet, and a coil.

10. The camera according to claim 4, wherein a moving distance of the first lens group ranges from 300 μm to 1500 μm.

11. The camera according to claim 1, wherein the focusing object distance of the lens assembly in the second mode is less than or equal to 30 mm.

12. The camera according to claim 1, wherein the image sensor comprises:
a pixel array;
a flexible film layer that is light transmissive, wherein the flexible film layer and the pixel array are stacked; and
a driving device, arranged on the flexible film layer; wherein the driving device is configured to change a curvature of the flexible film layer to correct a field curvature of the lens assembly.

13. The camera according to claim 12, wherein the driving device comprises a piezoelectric device, in condition of a voltage being applied to the piezoelectric device, the piezoelectric device deforms to drive the flexible film layer to deform.

14. The camera according to claim 13, wherein the piezoelectric device comprises a piezoelectric thin film.

15. The camera according to claim 13, wherein the piezoelectric device is arranged at an edge position of the flexible film layer.

16. The camera according to claim 15, wherein the piezoelectric device is connected to the flexible film layer around an outer edge position of the flexible film layer.

17. The camera according to claim 12, wherein a microlens array is formed on the flexible film layer, and the microlens array is configured to focus light toward the pixel array.

18. The camera according to claim 17, wherein the microlens array is formed on a surface of the flexible film layer away from the pixel array.

19. A camera, comprising:
an image sensor; and
a lens assembly, wherein the lens assembly is configured to form an image on the image sensor, the lens assembly includes a plurality of lens groups, the plurality of lens groups are arranged along an optical axis of the lens assembly;
wherein at least one of the plurality of lens groups is movable relative to the image sensor to switch the lens assembly between a macro mode and a microscopic mode; a focusing object distance of the lens assembly in the first mode is less than a focusing object distance of the lens assembly in the second mode; the focusing object distance of the lens assembly in the microscopic mode is less than 10 mm.

20. An electronic apparatus, comprising a camera;
wherein the camera comprises:
an image sensor; and
a lens assembly, wherein the lens assembly is configured to form an image on the image sensor, the lens assembly comprises a plurality of lens groups, and the plurality of lens groups are arranged along an optical axis of the lens assembly;
wherein at least one of the plurality of lens groups is movable relative to the image sensor to switch the lens assembly between a first mode and a second mode; a focusing object distance of the lens assembly in the first mode is less than a focusing object distance of the lens assembly in the second mode; the focusing object distance of the lens assembly in the first mode is less than 10 mm.
